(19) United States
(12) Patent Application Publication
(10) Pub. No.: US 2013/0094900 A1
(43) Pub. Date: Apr. 18, 2013

(54) HARDFACING ALLOY, METHODS, AND PRODUCTS THEREOF

(71) Applicants: Grant R. FOLKMANN, Tomball, TX (US); Keith E. MOLINE, Houston, TX (US)

(72) Inventors: Grant R. FOLKMANN, Tomball, TX (US); Keith E. MOLINE, Houston, TX (US)

(73) Assignee: DEVASCO INTERNATIONAL INC., Tomball, TX (US)

(21) Appl. No.: 13/275,023

(22) Filed: Oct. 17, 2011

(51) Int. Cl. F16B 7/18; B32B 15/02; B32B 15/18; B23K 9/00; B23K 31/02; C22C 38/00; C22C 37/00; C22C 37/10; B23K 9/173; C23C 4/08; B32B 15/01; C22C 38/12

(52) U.S. Cl. 403/343; 428/576; 428/685; 428/684; 428/638; 428/656; 219/137 R; 420/123; 420/121; 420/10; 420/99; 420/27; 420/14; 420/9; 219/74; 427/456; 228/101

(57) ABSTRACT

Disclosed is a hardfacing alloy deriving its usefulness from carbides and borides of molybdenum and niobium. The alloy does not rely on chromium as an alloying agent. The hardfacing alloy is capable of being applied to a number of industrial substrates in a crack-free manner, and once applied convert the substrate to a wear- and abrasion-resistant material having an extended service life, even when subjected to harsh wear conditions.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to the field of hardfacing alloys, and more particularly relate to hardfacing metal alloys exhibiting high abrasion resistance and extended wear characteristics for use in products and applications that are subject to harsh environments.

2. Description of the Related Art

The exploration and extraction of minerals from the earth is a difficult and expensive process. Drilling for hydrocarbons typically requires complex engineering and careful materials selection. The equipment involved in oil and gas exploration and production is often subjected to harsh abrasion and destructive tribological mechanisms during use, particularly in subterranean environments. Therefore, a prudent oil and gas operation often seeks to protect select equipment and components used in such processes through the use of hardfacing alloys.

There has to date been a severe problem with the service life of tool joints and stabilizers used in earth boring operations such as drilling a bore hole in the earth to a formation or formations from which oil and/or gas are to be produced, as approximately 95 percent of the surface of the earth is composed of silicious materials which are very abrasive and which cause considerable wear on the surfaces of tool joints and stabilizers, as well as on wear prone surfaces of other industrial products.

There have been numerous attempts to provide hardfacing alloys suitable for welding protective hardfacing (referred to as “hardbanding”) on tool joints. A number of earlier hardbanding processes for extending the wear life of tool joints have been described, such as for example in U.S. Pat. No. 4,256,518 and in U.S. Pat. No. 3,067,593. Also, for the use of hardbanding materials, such as tungsten carbide particles to form a hardened surface at a tool joint to increase wear resistance, reference is made to U.S. Pat. No. 3,989,554, as well as in “History of Oil Well Drilling by J. E. Brantly (Gulf Publishing Company, Houston, Tex., 1971). Reference may also be made to U.S. Pat. Nos. 2,259,232; 2,262,211; 4,431,902; and 4,942,059 which illustrate various prior art attempts to hardband tool joints.

Historically, and in practice, tool joints on drilling strings (pipe) such as used in drilling oil and gas wells have been faced at the bottom of the box end with tungsten carbide to resist the abrasion of the rock earth in the drill hole on the tool joint. This has three disadvantages. Tungsten carbide is expensive, it acts as a cutting tool to cut the well casing in which it runs, and the matrix is a soft steel which erodes away easily to allow the carbide particles to fall away.

Most prior art hardfacing materials harder than silicious earth materials are brittle and crack in a brittle manner after solidification and upon cooling due to the brittle nature of its structure and the inability of the structure to withstand solidification shrinkage stresses and typically emit sound energy upon cracking as well as causing considerable casing wear as previously stated. These hardfacing materials are alloys which belong to a well-known group of “high Cr-irons” and their high abrasion resistance is derived from the presence in the microstructure of the Cr-carbides of the eutectic and/or hypereutectic type. In the as-welded condition, whatever the precautions taken, these hardfacing overlays always show a more or less dense network of cracks.

Wear by abrasion mechanisms always has been, and still remains a main concern in many segments of industry: drilling, mining, quarrying, processing and handling of minerals in general and of highly silicious minerals in particular.

Many base materials and hardfacing alloys have been developed in the past with the aim of achieving the highest possible abrasion resistance compatible with factors such as their decay by mechanical incidences: ruptures and/or spalling. Typical examples of very highly abrasion resistant hardfacing alloys can be found in the well known family of the high Cr-Irons (high chromium irons), and in particular by a high Cr-Iron such as those described in U.S. Pat. No. 5,244,559.

These high-chromium based alloys derive their abrasion resistance properties essentially from their metallographical structure, based on the precipitation of primary Cr-Carbides. However, structures of this type are affected by a high degree of brittleness and a high sensitivity to cracking when deposited by welding. Consequently, they exhibit quite a high risk of spalling (chipping, flaking or cracking) under actual service conditions. In addition, these types of alloys are not characterized by particularly attractive or low friction coefficients.

As the foregoing discussion indicates, industry's desire for an alloy with exemplary wear resistance and a crack-free deposit has never been fully satisfied. While chromium carbide type alloy systems provide stout wear resistance, they are generally brittle and result in cracking.

Prior to U.S. Pat. No. 7,361,411 cracked hardfacing materials were rarely, if ever, implemented. Even with the advent and proven viability of the '411 invention concerns still remain with cracked hardfacing. Namely, there is still a concern that cracks can result in the hardfacing material spalling off the substrate (see, “The Procedure Handbook of Arc Welding,” 13^{th} Ed., Lincoln Electric Co., p. 13.7-11). Hardfaced materials, such as tool joints, are often exposed to corrosive environments and crack-faces can serve as a propogation point for corrosion. Cracked hardfacing in a corrosive environment also presents an additional concern in that the cracks will allow corrosive materials to penetrate the hardfacing and attack the base material. By being capable of crack-free application, the present invention is able to eliminate the concerns associated with cracking.

The presently disclosed alloy is advantageous to the prior alloys in that it does not rely on chromium carbides for its wear and abrasion resistance—Instead, it relies on carbides and borides of molybdenum and/or niobium. Chromium carbides, as well as carbides of other metals, are typically coarse and aggressive with needle-like structures, making them less desirable to use. Advantageously, the carbides and borides of molybdenum and/or niobium are typically finer and more spherical than other metallic carbides. Moreover, the carbides and borides of molybdenum and niobium of the presently disclosed alloy do not exhibit long, needle-like extensions. Their smaller nature, combined with their less aggressive physical structure, puts less strain on the alloy's supporting matrix, which in turn avoids cracking. In at least one preferred embodiment, the matrix is comprised of a fine martensitic microstructure, which enforces enhanced hardness and wear resistance to the alloy while at the same time allows for the alloy to remain free of cracks. In at least one preferred embodiment the alloy presently disclosed can be deposited upon a substrate in a crack-free manner. Moreover, the wear data of the presently disclosed alloy rivals, and often exceeds, chrome carbide type hardfacing.

Chromium as an alloying ingredient presents issues beyond the formation of crack susceptible chromium carbides. The American Iron and Steel Institute (AISI) 4137 tool joint steel typically has a chromium content between 0.80% and 1.10%. Many of the high chromium hardfacing materials, such as those disclosed in U.S. Pat. No. 5,224,559, have chromium contents up to about 35 weight percent. Such high chromium contents create a dissimilarity between the welding alloy and the base material. It is well known in the art that welding dissimilar materials can lead to complications such as poor operability (e.g., spatter and porosity), and insufficient bonding (see, for example, U.S. Patent Publication No. US2010/0233501).

Furthermore, chromium alloyed metals present another challenge due to the presence of hexavalent chromium (Cr(VI)) in their weld fumes. In recent years, the United States Occupational Safety and Health Administration (OSHA) has devoted a great deal of attention to hexavalent chromium safety. According to OSHA Publication Number 3373-10, “Hexavalent chromium may . . . be present in fumes generated during the production or welding of chrome alloys.” (www.osha.gov/Publications/OSHA-3373-hexavalent-chromium.pdf, page 3). OSHA states that exposure to Cr(VI) can lead to adverse health effects such as: “lung cancer in workers who breathe airborne Cr(VI); irritation or damage to the nose, throat, and lungs (respiratory tract) if Cr(VI) is inhaled; and irritation or damage to the eyes and skin if Cr(VI) contacts these organs.” (www.osha.gov/Publications/OSHA-3373-hexavalent-chromium.pdf, page 5). Hence, OSHA has imposed very strict workplace exposure limits for Cr(VI). Often, compliance with the OSHA Cr(VI) restrictions requires businesses to invest in very expensive fume extraction and fume treatment equipment.

The presently disclosed alloy does not contain chromium as an alloying element, so its weld fumes are functionally devoid of Cr(VI). Therefore, the alloy presents a significant advantage to previously described hardfacing alloys as it avoids all of the health hazards and compliance expenses associated with Cr(VI).

Extensive testing of weld deposits employing carbides and borides of molybdenum and niobium has underscored the superiority of the presently disclosed alloy. Namely, the alloy system presently disclosed has revealed itself: devoid of the welding disadvantages associated with chromium; more forgiving in terms of preheating prior to welding and cooling rates after welding; capable of being deposited upon industrial substrates without cracking; of exceptional hardness; and well situated to offer a significant contribution in protecting downhole equipment from wear, abrasion, and other tribological factors.

The invention disclosed and taught herein is directed to a hardfacing alloy exhibiting strong hardness properties and high abrasive wear resistance, wherein the alloy does not rely on chromium as an alloying agent and which includes molybdenum, niobium, manganese, boron, silicon, and/or carbon as well as iron as a majority component.

### BRIEF SUMMARY OF THE INVENTION

The hardfacing alloy of the present disclosure is particularly suited for welding on wear prone surfaces such as tool joints and stabilizers where it can provide protection from abrasion and detrimental tribological mechanisms. Moreover, the hardfacing alloy disclosed herein can be applied crack-free to a substrate and does not rely on chromium for its wear resistance. Therefore, it is able to circumvent the problems of hexavalent chromium found in the weld fumes of chromium containing metals.

In welding the hardfacing alloy of the present disclosure, it is often a prerequisite to a crack-free deposit to preheat the base material. By “crack-free”, it is meant that no cracks develop that are visible to the naked eye. For a general discussion of preheating, reference is made to “Jefferson's Welding Encyclopedia” (18^{th} edition, 1997, published by the American Welding Society). In general, preheating lowers the yield strength of most metals and allows stresses to be relieved or reduced. (Jefferson's, p. 399.) Welding introduces a significant amount of heat to the materials involved. The intense heat associated with welding can lead to localized expansion and/or distortion of the base material and/or the weld beads, which in turn can lead to localized stresses. Furthermore, welding involves a molten weld pool. The weld pool solidifies rapidly, often contracting as it does. This rapid contraction can introduce localized stresses to the weld area, particularly the weld beads themselves. Such localized stresses can be sufficient to cause a weld to crack. Preheating the base material equalizes the temperature of the workpiece and the welded area thereby avoiding or lessening local expansion, contraction, and/or distortion and the stresses tied thereto. Similarly, preheating the base material creates a larger thermal mass so that the temperature gradient between the weld area and the base material is reduced, thereby lessening heat flow from the weld area and providing for a slower cooling rate. Proper preheat procedure depends upon a number of factors including the project objectives, the materials involved, the workpiece size and shape, and the welding process to be used. Proper preheat procedures, when required, will be known to those of ordinary skill in the art without undue experimentation.

In at least one embodiment of the present disclosure, the hardfacing alloy is typically, but not necessarily, welded to a surface using a tubular wire often comprising a metallic sheath with a powdered metal core, although other application methods may be used. In at least one preferred embodiment of the disclosure, the alloy has an undiluted chemistry comprising by weight about 3.0% to about 7.0% molybdenum, about 3.0% to about 7.0% niobium, about 0.5% to about 3.5% manganese, about 0.5% to about 2.0% boron, about 0.5% to 2.0% about Silicon, and from about 0.3% to about 3.0% carbon with the balance comprising iron (Fe) and other trace elements.

In a further embodiment of the present disclosure, the undiluted hardfacing alloy, in an as-welded condition, exhibits hardness on the Rockwell-C scale from about 59 R_{c} to 67 R_{c}. When welded in a single layer on an appropriately preheated (for example and without limitation, 500F), typical tool joint (e.g., of AISI 4137 steel), and slow-cooled, one preferred embodiment of the alloy exhibits hardness from about 55 R_{c} to 67 R_{c}. The alloy also exhibits excellent abrasive wear resistance. When deposited in a single layer on typical tool joint material, slow cooled, and tested according to the American Society for Testing and Materials (ASTM) G65 Dry Sand Rubber Wheel test (or the equivalent), in at least one preferred embodiment of the present disclosure, the alloy described herein exhibits a wear rate from about 0.175 g to about 0.275 g weight loss per 6,000 revolutions.

In a further embodiment of the present disclosure, the hardfacing alloy described herein is capable of being applied on typical, tool joint material (preheated when appropriate) in a crack-free condition. In addition, the present hardfacing alloy is capable of being applied over various preexisting hardfacing alloys in a crack-free manner. Moreover, after a welding operation is complete, the tool joint can be left exposed to ambient air (as opposed to being wrapped in insulation and slow-cooled), and the weldment and substrate remain crack-free.

In a further embodiment of the present disclosure, the alloy is capable of being deposited in a crack-free manner, and remaining crack-free even after rapid post weld cooling rates. When deposited in a single layer upon an industrial substrate (preheated when appropriate) and then after deposition rapidly cooled by quenching in a fluid medium (e.g., including but not limited to water, oil, air), immediately after welding, a preferred embodiment of the alloy remains crack-free.

Embodiments of the present disclosure include the various hardfacing alloy compositions, tool joints, and stabilizers hardbanded with the hardfacing alloy compositions. For example, tool joints which connect together drill pipe have an internally threaded box for reception of a threaded pin member, a cylindrical outer surface and a layer of the hardbanding alloy composition welded on the cylindrical outer surface, and on its pin member if desired, which provides tool joint protection from silicious abrasions. Also, stabilizers connected to drill pipe having stabilizer ribs hardbanded with the hardfacing composition which stabilize the drill pipe in the well bore and casing.

Other embodiments of the present disclosure are industrial products having surfaces requiring high abrasion resistance hardfaced with the hardfacing alloy of the invention welded to their wear prone surface, such as abrasion resistance plates and other industrial structures requiring abrasion resistance, as previously set forth.

Advantageously, the hardfacing alloy described herein can be deposited in single, and/or multiple layers and on top of other preexisting hardfacing alloys.

It is yet a further object of the present disclosure to provide such a balanced metal to metal hardfacing alloy which can be utilized to hardband and thereby improve the service life of tool joints connecting drill pipe rotated and moved in casing in earth boring.

A further object of the present disclosure is to provide a hardfacing alloy which can be utilized to hardband stabilizers which as welded withstands abrasion by silicious formations of the earth and other silicious materials with balanced metal to metal resistance.

A further object of the present invention is provide a wear resistant surface that does not have a deleterious impact on other downhole equipment such as casing pipe.

A further object of the present disclosure is to provide other industrial products subject to such abrasion having the hardfacing alloy welded on surfaces subject to such abrasion.

It is a further object of the present disclosure to provide such a hardfacing alloy for industrial products which have this abrasion resistant alloy welded on their abrasion prone surfaces.

Other and further objects, features, and advantages of embodiments of the invention appear throughout.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIG. 1 illustrates a fragmentary longitudinal sectional view of a box of a tool joint with a raised hardband according to the invention.

FIG. 2 illustrates a view similar to FIG. 1 illustrating a pin of the tool joint with a raised hardband according to the invention.

FIG. 3 illustrates a view similar to FIG. 1 illustrating flush hardbanding of a box of the tool joint according to the invention.

FIG. 4 illustrates a view similar to FIG. 1 illustrating flush hardbanding of a pin of the tool joint according to the invention.

FIG. 5 illustrates a longitudinal view of a stabilizer hardbanded according to the invention.

FIG. 6 illustrates a cross-sectional view of a cored wire with a butt seam joint.

FIG. 7 illustrates a cross-sectional view of a cored wire with an overlap seam joint.

FIG. 8 illustrates a diagrammatic view of apparatus suitable for welding a cored wire of the hardfacing alloy in open, gas shielded or submerged arc.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DEFINITIONS

The following definitions are provided in order to aid those skilled in the art in understanding the detailed description of the present invention.

The term “hardfacing” as used herein refers to a layer of metal deposited onto a base metal to provide a surface, which is harder and more wear resistant than the softer base metal.

The term “hardbanding” as used herein refers to the hardfacing of cylindrical industrial products such as tool joint. For example, a typical hardbanding process consists of circumferentially welding around a tool joint three, single-layer, one-inch wide beads each of which ties into the bead immediately adjacent. Various deposition processes, bead dimensions, and deposit patterns are also applicable.

The term “Rockwell Hardness”, as used herein, refers to the Rockwell method of measuring hardness of a metal material by means of resistance to penetration, wherein the hardness is measured by pressing an indentor under a specific, known and constant load of pressure into the surface of the metal, and then measuring how far the indentor was able to penetrate. This term, as used herein, refers to the A, B and C hardness scales (typically noted as Rₐ, R_{b}, or R_{c}, respectively), such as described and detailed in ASTM E18-08a, entitled “Standard Test Methods for Rockwell Hardness of Metallic Materials,” among other sources.

As used herein, the term “Vickers Hardness Test” refers to a method of quantifying a materials' ability to resist plastic deformation when force is applied from a standard source, the result of which is known as the “Vickers Pyramid Number” or (HV). Vickers hardness numbers are typically reported as xxxHVyy, e.g. 440HV30, or xxxHVyy/zz if duration of force differs from 10 s to 15 s, e.g. 440Hv30/20, where: 440 is the hardness number, HV gives the hardness scale (Vickers), 30 indicates the load used in kg, and 20 indicates the loading time if it differs from 10 s to 15 s.

As used herein, the term “wear rate” refers to the rate at which an element degrades during a physical operation. The wear rate is a function of a material's weight loss due to abrasive forces and encompasses concepts described in the ASTM G65 Dry Sand Rubber Wheel Test specification.

It must be noted that, as used in this specification and the appended claims, the singular forms “a”, “an” and “the” include plural references unless the content clearly dictates otherwise. Thus, for example, reference to “an alloy” includes a mixture of two or more such agents, and the like.

### DETAILED DESCRIPTION

The written description of specific structures and functions below are not presented to limit the scope of what Applicants have invented or the scope of the appended claims. Rather, the written description is provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Applicants have created an improved hardfacing alloy composition exhibiting strong wear and abrasion resistance on surfaces after their application, and resist “cracking”, thus extending the life of the metal materials that are surfaced with the hardfacing alloy of the present disclosure. The hardfacing alloy of the present disclosure is also formulated so as to reduce the harmful health affects of using and applying the alloy by not selecting chromium as an alloying element.

In at least one preferred embodiment, the hardfacing composition of the present invention comprises by weight from about 0.3% to about 5.0% carbon, about 2.5% to about 8.0% molybdenum, about 2.5% to about 8.0% niobium, about 0.0% to about 5.0% manganese, about 0.0% to about 3.0% boron, and about 0.0% to about 3.0% silicon, with the balance being iron and impurities as trace elements. In at least one preferred embodiment the bulk chemistry is melted with electric arc and solidifies to form carbides and borides of niobium and molybdenum.

More particularly, the hardfacing composition of the present invention comprises carbon in an amount of about 0.3 wt. %, about 0.4 wt. %, about 0.5 wt. %, about 0.6 wt. %, about 0.7 wt. %, about 0.8 wt. %, about 0.9 wt. %, about 1.0 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, about 2.0 wt. %, about 2.1 wt. %, about 2.2 wt. %, about 2.3 wt. %, about 2.4 wt. %, about 2.5 wt. %, about 2.6 wt. %, about 2.7 wt. %, about 2.8 wt. %, about 2.9 wt. %, about 3.0 wt. %, about 3.1 wt. %, about 3.2 wt. %, about 3.3 wt. %, about 3.4 wt. %, about 3.5 wt. %, about 3.6 wt. %, about 3.7 wt. %, about 3.8 wt. %, about 3.9 wt. %, about 4.0 wt. %, about 4.1 wt. %, about 4.2 wt. %, about 4.3 wt. %, about 4.4 wt. %, about 4.5 wt. %, about 4.6 wt. %, about 4.7 wt. %, about 4.8 wt. %, about 4.9 wt. %, and about 5.0 wt. %, as well as ranges within any two of these composition values, including but not limited to from about 0.8 wt. % to about 3.2 wt. %, or from about 2.1 wt. % to about 4.7 wt. %, inclusive.

The composition further comprises molybdenum and niobium, both elements being present (individually) in an amount of about 2.5 wt. %, about 2.6 wt. %, about 2.7 wt. %, about 2.8 wt. %, about 2.9 wt. %., about 3.0 wt. %, about 3.1 wt. %, about 3.2 wt. %, about 3.3 wt. %, about 3.4 wt. %, about 3.5 wt. %, about 3.6 wt. %, about 3.7 wt. %, about 3.8 wt. %, about 3.9 wt. %, about 4.0 wt. %, about 4.1 wt. %, about 4.2 wt. %, about 4.3 wt. %, about 4.4 wt. %, about 4.5 wt. %, about 4.6 wt. %, about 4.7 wt. %, about 4.8 wt. %, about 4.9 wt. %, about 5.0 wt. %, about 5.1 wt. %, about 5.2 wt. %, about 5.3 wt. %, about 5.4 wt. %, about 5.5 wt. %, about 5.6 wt. %, about 5.7 wt. %, about 5.8 wt. %, about 5.9 wt. %, about 6.0 wt. %, about 6.1 wt. %, about 6.2 wt. %, about 6.3 wt. %, about 6.4 wt. %, about 6.5 wt. %, about 6.6 wt. %, about 6.7 wt. %, about 6.8 wt. %, about 6.9 wt. %, about 7.0 wt. %, about 7.1 wt. %, about 7.2 wt. %, about 7.3 wt. %, about 7.4 wt. %, about 7.5 wt. %, about 7.6 wt. %, about 7.7 wt. %, about 7.8 wt. %, about 7.9 wt. %, and about 8.0 wt. %, as well as ranges within any two of these composition values, including but not limited to from about 3.8 wt. % to about 7.2 wt. %, or from about 4.1 wt. % to about 6.7 wt. %, inclusive. In accordance with further, non-limiting aspects of the present invention, in some instances, the amounts of molybdenum and niobium in the alloy are substantially equivalent, wherein by “substantially equivalent” it is meant that the amounts of both elements present within the alloy differ by no more than about 0.9 wt. %, and advantageously less, such as 0.8%, 0.7%, 0.6%, 0.5%, 0.4%, 0.3%, 0.2%, or 0.1%.

The hardfacing composition of the present invention also optionally comprises manganese, and when manganese is present, it is preferably present in an amount of about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1.0 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, about 2.0 wt. %, about 2.1 wt. %, about 2.2 wt. %, about 2.3 wt. %, about 2.4 wt. %, about 2.5 wt. %, about 2.6 wt. %, about 2.7 wt. %, about 2.8 wt. %, about 2.9 wt. %, about 3.0 wt. %, about 3.1 wt. %, about 3.2 wt. %, about 3.3 wt. %, about 3.4 wt. %, about 3.5 wt. %, about 3.6 wt. %, about 3.7 wt. %, about 3.8 wt. %, about 3.9 wt. %, about 4.0 wt. %, about 4.1 wt. %, about 4.2 wt. %, about 4.3 wt. %, about 4.4 wt. %, about 4.5 wt. %, about 4.6 wt. %, about 4.7 wt. %, about 4.8 wt. %, about 4.9 wt. %, and about 5.0 wt. %, as well as ranges within any two of these composition values, including but not limited to from about 0.5 wt. % to about 4.1 wt. %, or from about 2.1 wt. % to about 3.5 wt. %, inclusive.

The alloy composition of the present invention also optionally comprises boron, and when boron is present, it is preferably present in an amount of about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1.0 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, about 2.0 wt. %, about 2.1 wt. %, about 2.2 wt. %, about 2.3 wt. %, about 2.4 wt. %, about 2.5 wt. %, about 2.6 wt. %, about 2.7 wt. %, about 2.8 wt. %, about 2.9 wt. %, and about 3.0 wt. %, as well as ranges within any two of these composition values, including but not limited to from about 0.5 wt. % to about 2.8 wt. %, or from about 1.1 wt. % to about 2.3 wt. %, inclusive.

Finally, alloy composition of the present invention also optionally comprises silicon, and when silicon is present, it is preferably present in an amount of about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1.0 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, about 2.0 wt. %, about 2.1 wt. %, about 2.2 wt. %, about 2.3 wt. %, about 2.4 wt. %, about 2.5 wt. %, about 2.6 wt. %, about 2.7 wt. %, about 2.8 wt. %, about 2.9 wt. %, and about 3.0 wt. %, as well as ranges within any two of these composition values, including but not limited to from about 0.5 wt. % to about 2.8 wt. %, or from about 1.1 wt. % to about 2.1 wt. %, inclusive.

In one preferred embodiment, the hardfacing alloy of the present invention has an all weld metal hardness of from about 55 Rc to 67 Rc. In addition, it exhibits single layer hardness on a substrate such as a tool joint (e.g., of AISI 4137 steel), of about 55 Rc to 67 Rc, and is effective in abrasion resistance due to its formation of molybdenum carbides, niobium carbides, molybdenum borides, and niobium borides. In at least one preferred embodiment, the alloy can be deposited upon itself and over various other alloys in a crack-free state.

In one preferred embodiment, the hardfacing alloy composition is preferably deposited by metal-cored tubular wire containing the hardfacing alloy used under gas shielding. However, in another embodiment, the hardfacing alloy composition is deposited by metal-cored tubular wire without gas shielding. Thus, it should be noted that the hardfacing alloy composition of the present disclosure can be deposited on a metal substrate material by any suitable application means, such as welding means and methods, including but not limited to open arc, gas, flux shielded, or shielded metal arc. The welding electrode can be a solid wire, cored electrode, coated electrode or coated cored electrode. When the electrode is a coated and/or cored electrode, the coating and/or fill material in the core can include alloying agents, fluxing agents, slag agents, gas generating agents, etc. The electrode can be a self shielding electrode and/or be used in the presence of a shielding gas. The hardfacing alloy can also be applied by directly depositing the metal particles on the workpiece and/or can be spray coated on the workpiece. As such, the hardfacing alloy can be applied by a variety of processes such as, but not limited to, submerged arc welding (SAW), shielded metal arc welding (SMAW), flux-cored arc welding (FCAW), gas metal arc welding (GMAW), gas tungsten arc welding (TIG), metal spraying, etc.

The preferred and exemplary hardfacing alloy composition in accordance with aspects of the present disclosure is set forth in the table below, by weight percent:

| | |
|---|---|
| C | 0.0-5.0% |
| B | 0.0-2.0% |
| Mn | 0.0-5.0% |
| Mo | 2.5-8.0% |
| Nb | 2.5-8.0% |
| Si | 0.1-2.0% |
| Fe | balance |

In particular, the hardfacing alloy composition comprises carbon in an amount ranging from about 0.0 weight percent to about 3.0 weight percent, more preferably from about 0.3 to about 3.0 weight percent; molybdenum in an amount ranging from about 2.5 weight percent to about 8.0 weight percent, inclusive, and more preferably from about 3.0 weight percent to about 7.0 weight percent, inclusive; niobium in an amount ranging from about 2.5 weight percent to about 8.0 weight percent, inclusive, and more preferably from about 3.0 weight percent to about 7.0 weight percent, inclusive; manganese in an amount ranging from about 0.0 weight percent weight percent to about 5.0 weight percent, inclusive, and more preferably from about 0.5 weight percent to about 3.5 weight percent, inclusive; boron, in an amount ranging from about 0.0 weight percent to about 2.0 weight percent, inclusive, and more preferably from about 0.5 weight percent to about 2.0 weight percent, inclusive; silicon, in an amount ranging from about 0.1 weight percent to about 2.0 weight percent, inclusive, and more preferably from about 0.5 weight percent to about 2.0 weight percent, inclusive; wherein the balance of the alloy composition comprises iron, including impurities in trace amounts.

The hardfacing alloy described herein, after application to a substrate, exhibits a hardness as measured on the Rockwell-C scale ranging from about 55 R_{c} to about 67 R_{c}, inclusive, and more particularly a hardness ranging from about 59 R_{c} to about 67 R_{c}, inclusive, such as from about 60 R_{c} to about 65 R_{c}, and any increment there between. When deposited on typical tool joint steel in a single or double layer, the hardfacing alloy described herein further exhibits a wear rate ranging from about 0.175 g weight loss per 6,000 revolutions to about 0.275 g weight loss per 6,000 revolutions, inclusive, as determined in accordance with the ASTM G65 Dry Sand Rubber Wheel test.

### MODES OF CARRYING OUT THE INVENTION

Before describing the present invention in detail, it is to be understood that this invention is not limited to particular formulations or process parameters as such may, of course, vary. It is also to be understood that the terminology used herein is for the purpose of describing particular embodiments of the invention only, and is not intended to be limiting.

Although a number of methods and materials similar or equivalent to those described herein can be used in the practice of the present invention, the preferred materials and methods are described herein.

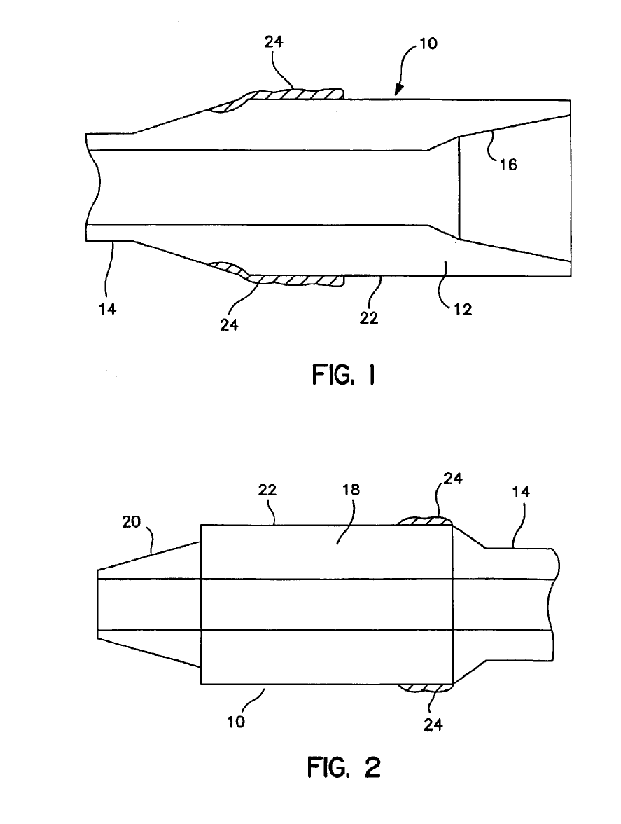

Turning now to the Figures, and in particular FIGS. 1 and 2, a tool joint for drill pipe 10 is illustrated which has a box 12 at the end of the drilling pipe 14 which is internally threaded at 16 which threadedly receives a pin 18 having co-acting threads 20 to the threads 16 so that the pin 18 can be threaded into box 12. The pin 18 forms the end of a drill pipe, such as 14, so that a string or joints of pipe can be threadedly secured together and disconnected for drilling oil, gas, and other wells.

The box 12 and the pine 18 are enlarged and have a outer cylindrical surfaces 22 having an outer diameter greater than the outer diameter of the drill pipe 14 for deposit of the beads 24 of the hardbanding alloy of the present invention.

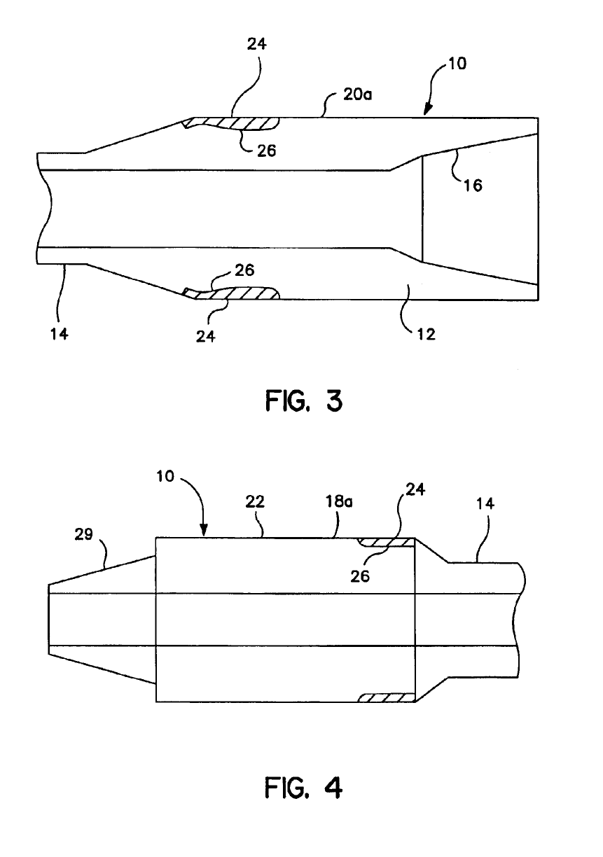

Referring now to FIGS. 3 and 4 where the reference letter “a” has been added to reference numerals corresponding to those same elements in FIGS. 1 and 2, the tool joint 10a of FIGS. 3 and 4 is identical to that of the tool joint 10 of FIGS. 1 and 2 except that it has a reduced cylindrical portion 26 formed by either the removal of a circumferential band of material from the outer cylindrical surfaces 22a of the box 12a and the pin 18a or was originally formed with these reduced diameter sections 22a, and the hardbanding alloy in beads 24a is welded in this space so that the surface of the weld deposited hardfacing is substantially flush with the outer cylindrical surface of the box 12a and the pin 18a.

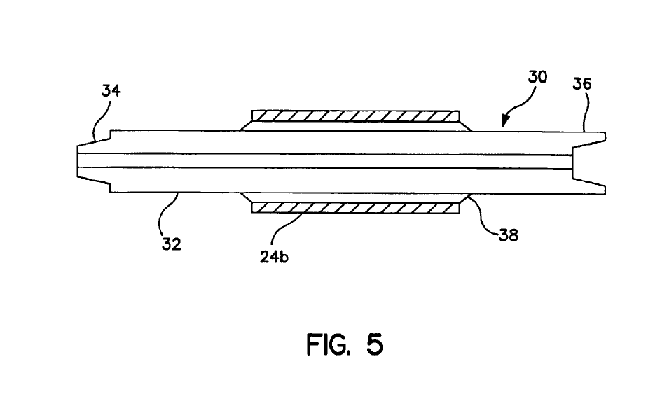

Referring to FIG. 5, a stabilizer 30 according to the invention is illustrated which has an elongated cylindrical or pipe-like body 32 having the pin 34 and box 36 for connection in a string of a hollow drill pipe (not shown), the stabilizer 30 having stabilizer ribs 38 extending outwardly from the body 32 for stabilizing the drill pipe in a well bore (not shown) to which the stabilizer ribs 38 the hardbanding alloy 24b is welded.

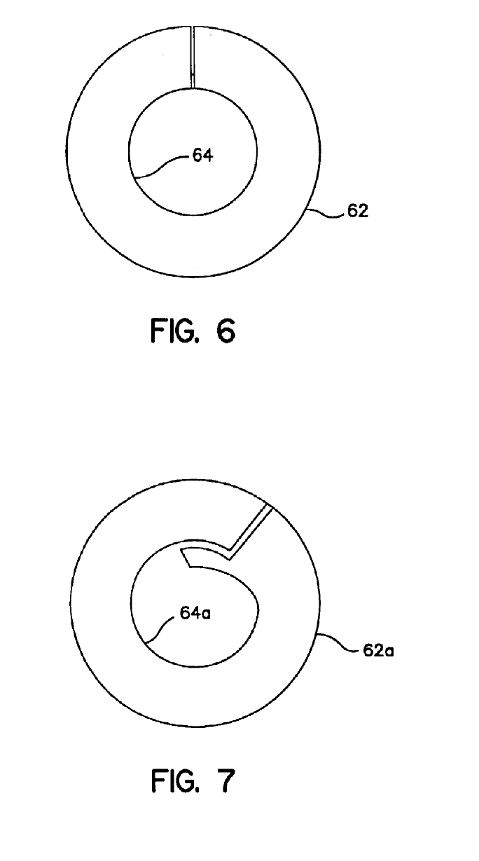

Referring now to FIGS. 6 and 7, tubular butt seam wires 62 and 62a having cores 64 and 64a of the weldable alloy composition are illustrated. In both cored tubular wires 62 and 62a, the cores 64 and 64a can be completely metallic powders, called metal cored, or a mixture of metal and mineral powders, called flux cored. In each case, the powdered metal core with the metallic sheath make up the alloy composition of the hardfacing or hardbanding alloy of the present invention. Since cored wires are well known in the art and trade, no further description is given thereof or deemed necessary.

After time in service where abrasion by earth materials or silicious or other materials may abrade away an area of the hardfacing, additional hardbanding may be applied as indicated above without essential damage to the box 12 or pin 20 of the tool joint 10 and on the stabilizer ribs 38 of the stabilizer 30.

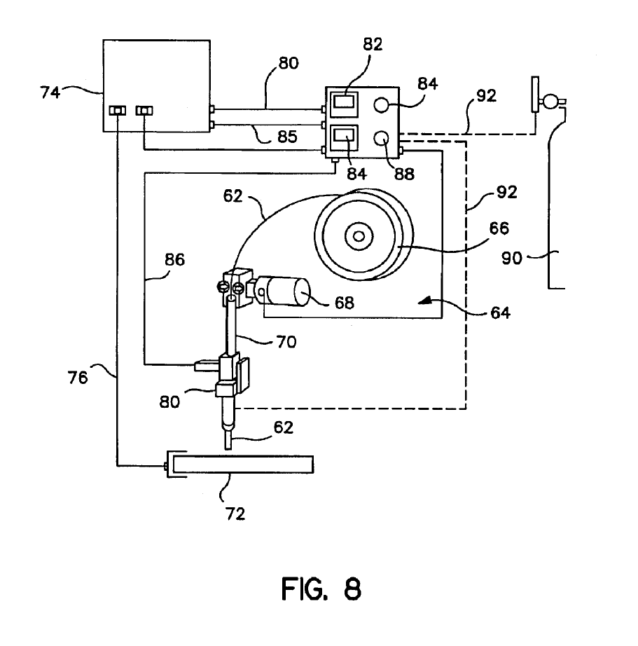

Referring now to FIG. 8, which schematically illustrates an exemplary, non-limiting apparatus useful in carrying out methods of the invention, the apparatus 64 includes a reel 66, a cored wire 62 (or 62a) wound around it, driven by the wire drive motor 68 through the guide tube 70 to the industrial product 72 to be hardfaced or hardbanded. A direct current, constant voltage power source 74 provides electrical energy through the electrical power cable 76 to the industrial product 72, and by the electric power cable 80 to the volt meter 82 and the voltage control 84. The electric cable 85 provides a voltage supply to the voltmeter and then through the electrode power cable 86 to the guide tube 70 and to the cored wire 62 or 62a.

When desired to be used, gas shielding is illustrated diagrammatically by the gas shielding source 90 through the gas tube 92 to the control switch 98 and to the guide tube 99 to provide shielding for electrodes requiring it.

The method of the invention for prolonging the surface life of tool joints, stabilizers, and other industrial products comprises hardfacing or hardbanding by tubular wire, in open arc, gas shielded or submerged arc, a layer of the hardbanding alloy of the present invention 24, 24a, or 24b to the outer cylindrical surface 22 or 22a of the box 12 or 12a of the tool joints 10 and 10a (FIGS. 1, 2), the outer cylindrical surface 22 of the pin 18 (FIGS. 3 and 4) and the stabilizer ribs 38 (FIG. 5). Normally, the weld beads 24 of the hardbanding alloy are about 3/32 to ¼ inch thick without detriment to the alloy properties and can be deposited in single or multiple layers. If desired, the surfaces 22a of the weld beads 24 can be substantially flush with the surface of the box 12a, and about 3/32 inch of material is removed.

The following examples are included to demonstrate preferred embodiments of the invention. It should be appreciated by those of skill in the art that the techniques disclosed in the examples which follow represent techniques discovered by the inventor(s) to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLES

### Example 1

A number of hardfacing alloys were prepared by mixing the elemental components listed in the various tables below in dry powder form, in the amounts shown. While the chemical analysis of exemplary, preferred alloy compositions of the invention are set forth in the tables below, these tables are merely examples of preferred embodiments and do not limit nor are they meant to completely define the present disclosure:

TABLE 1

| | |
|---|---|
| Carbon | 1.2% |
| Manganese | 3.0% |
| Silicon | 1.0% |
| Molybdenum | 5.25% |
| Niobium | 5.25% |
| Boron | 0.8% |

TABLE 2

| | |
|---|---|
| Carbon | 1.2% |
| Manganese | 0.0% |
| Silicon | 1.0% |
| Molybdenum | 5.25% |
| Niobium | 5.25% |
| Boron | 0.8% |

TABLE 3

| | |
|---|---|
| Carbon | 1.2% |
| Manganese | 3.0% |
| Silicon | 0.0% |
| Molybdenum | 5.25% |
| Niobium | 5.25% |
| Boron | 0.8% |

TABLE 4

| | |
|---|---|
| Carbon | 1.2% |
| Manganese | 3.0% |
| Silicon | 1.0% |
| Molybdenum | 10.0% |
| Niobium | 0.0% |
| Boron | 0.8% |

TABLE 5

| | |
|---|---|
| Carbon | 1.2% |
| Manganese | 3.0% |
| Silicon | 1.0% |
| Molybdenum | 5.25% |
| Niobium | 5.25% |
| Boron | 0.0% |

TABLE 6

| | |
|---|---|
| Carbon | 2.0% |
| Manganese | 3.0% |
| Silicon | 1.0% |
| Molybdenum | 5.25% |
| Niobium | 5.25% |
| Boron | 0.8% |

TABLE 7

| | |
|---|---|
| Carbon | 1.2% |
| Manganese | 3.0% |
| Silicon | 1.0% |
| Molybdenum | 3.8% |
| Niobium | 3.8% |
| Boron | 0.8% |

TABLE 8

| | |
|---|---|
| Carbon | 1.4% |
| Manganese | 3.0% |
| Silicon | 1.2% |
| Molybdenum | 5.5% |
| Niobium | 5.5% |
| Boron | 1.1% |

The hardfacing alloys set forth in Tables 1-8 as applied to tool joints, stabilizers, or surfaces of other industrial products has the properties previously set forth.

Other and further embodiments utilizing one or more aspects of the invention described above can be devised without departing from the spirit of Applicant's invention. For example, other additives can be included, and combinations of the transition metal components can be varied as appropriate for the specific application for which they are intended. Further, the various methods and embodiments of the aspects disclosed herein can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. An alloy composition comprising:
from about 0.0 weight percent to about 5.0 weight percent carbon;
from about 2.5 weight percent to about 8.0 weight percent molybdenum;
from about 2.5 weight percent to about 8.0 weight percent niobium;
from about 0.0 weight percent to about 3.0 weight percent boron; and
the balance of the composition being iron, including impurities in trace amounts.

2. The alloy of claim 1, wherein the composition comprises:
from about 0.3 weight percent to about 3.0 weight percent carbon;
from about 3.0 weight percent to about 6.0 weight percent molybdenum;
from about 3.0 weight percent to about 6.0 weight percent niobium;
from about 0.5 weight percent to about 5.0 weight percent manganese;
from about 0.0 weight percent to about 2.0 weight percent boron; and
from about 0.0 weight percent to about 3.0 weight percent silicon,
the balance of the composition being iron, including impurities in trace amounts.

3. The alloy of claim 1, wherein the composition comprises:
from about 1.0 weight percent to about 2.0 weight percent carbon;
from about 4.0 weight percent to about 6.0 weight percent molybdenum;
from about 4.0 weight percent to about 6.0 weight percent niobium;
from about 0.5 weight percent to about 3.5 weight percent manganese;
from about 0.5 weight percent to about 1.5 weight percent boron; and
from about 0.5 weight percent to about 2.0 weight percent silicon,
the balance of the composition being iron, including impurities in trace amounts.

4. The alloy of claim 1, wherein the composition comprises:
from about 1.0 weight percent to about 2.0 weight percent carbon;
from about 4.5 weight percent to about 6.5 weight percent molybdenum;
from about 4.5 weight percent to about 6.5 weight percent niobium;
from about 1.0 weight percent to about 3.5 weight percent manganese;
from about 0.5 weight percent to about 1.5 weight percent boron; and
from about 0.5 weight percent to about 2.0 weight percent silicon,
the balance of the composition being iron, including impurities in trace amounts.

6. The alloy composition of claim 1, wherein the molybdenum and the niobium are in approximately equal amounts.

7. The alloy of claim 1, wherein the alloy is contained in a metal core tubular wire.

8. The alloy of claim 1, wherein the alloy exhibits a hardness on the Rockwell-C Hardness scale of from about 55 Rc to about 67 Rc, inclusive.

9. The alloy of claim 1, wherein the alloy, deposited in a single or double layer upon a tool joint, exhibits a wear rate from about 0.175 g to about 0.275 g weight loss per 6,000 revolutions as determined using ASTM test method G-65.

10. The alloy of claim 1, wherein the alloy is deposited on the surface of a substrate in a crack-free manner.

11. An alloy composition comprising:
from about 0.0 weight percent to about 5.0 weight percent carbon;
from about 2.5 weight percent to about 8.0 weight percent molybdenum;
from about 2.5 weight percent to about 8.0 weight percent niobium;
from about 0.0 weight percent to about 5.0 weight percent manganese;
from about 0.0 weight percent to about 3.0 weight percent boron; and
from about 0.0 weight percent to about 3.0 weight percent silicon,
the balance of the composition being iron, including impurities in trace amounts.

12. The alloy of claim 11, wherein the composition comprises:
from about 0.3 weight percent to about 3.0 weight percent carbon;
from about 4.0 weight percent to about 6.0 weight percent molybdenum;
from about 4.0 weight percent to about 6.0 weight percent niobium;
from about 0.5 weight percent to about 5.0 weight percent manganese;
from about 0.0 weight percent to about 2.0 weight percent boron; and
from about 0.0 weight percent to about 3.0 weight percent silicon,
the balance of the composition being iron, including impurities in trace amounts.

13. The alloy of claim 11, wherein the composition comprises:
from about 1.0 weight percent to about 2.0 weight percent carbon;
from about 4.0 weight percent to about 6.0 weight percent molybdenum;
from about 4.0 weight percent to about 6.0 weight percent niobium;
from about 0.5 weight percent to about 3.5 weight percent manganese;
from about 0.5 weight percent to about 1.5 weight percent boron; and
from about 0.5 weight percent to about 2.0 weight percent silicon,
the balance of the composition being iron, including impurities in trace amounts.

14. The alloy of claim 11, wherein the composition comprises:
from about 1.0 weight percent to about 2.0 weight percent carbon;
from about 4.5 weight percent to about 6.5 weight percent molybdenum;
from about 4.5 weight percent to about 6.5 weight percent niobium;
from about 1.0 weight percent to about 3.5 weight percent manganese;
from about 0.5 weight percent to about 1.5 weight percent boron; and
from about 0.5 weight percent to about 2.0 weight percent silicon,
the balance of the composition being iron, including impurities in trace amounts.

16. The alloy composition of claim 11, wherein the molybdenum and the niobium are in approximately equal amounts.

17. The alloy of claim 11, wherein the alloy is contained in a metal core tubular wire.

18. The alloy of claim 11, wherein the alloy exhibits a hardness on the Rockwell-C Hardness scale of from about 55 Rc to about 67 Rc, inclusive.

19. The alloy of claim 11, wherein the alloy, deposited in a single or double layer upon a tool joint, exhibits a wear rate from about 0.175 g to about 0.275 g weight loss per 6,000 revolutions as determined using ASTM test method G-65.

20. The alloy of claim 11, wherein the alloy is deposited on the surface of a substrate in a crack-free manner.

21. A method of enhancing an industrial substrate, the method comprising:
selecting a substrate; and
applying an alloy onto at least a portion of a surface of the substrate, the alloy comprising:
from about 0.0 weight percent to about 5.0 weight percent carbon;
from about 2.5 weight percent to about 8.0 weight percent molybdenum;
from about 2.5 weight percent to about 8.0 weight percent niobium;
from about 0.0 weight percent to about 5.0 weight percent manganese;
from about 0.0 weight percent to about 3.0 weight percent boron; and
from about 0.0 weight percent to about 3.0 weight percent silicon,
the balance of the composition being iron, including impurities in trace amounts,
the alloy exhibiting a hardness on the Rockwell-C Hardness scale of from about 55 Rc to about 67 Rc, inclusive.

22. The method of claim 21, wherein the application of the alloy onto the substrate comprises electric arc welding.

23. The method of claim 21, wherein the application of the alloy onto the substrate comprises electric arc welding with a shielding gas.

24. The method of claim 21, wherein the application of the alloy onto the substrate comprises thermal spraying.

25. The method of claim 21, wherein the substrate is a metallic material selected from the group consisting of steel, stainless steel, iron base alloys, nickel, nickel base alloys, cobalt, cobalt base alloys, chromium, chromium base alloys, titanium, titanium base alloys, aluminum, aluminum base alloys, copper, copper base alloys, refractory metals, and refractory-metal alloys.

26. The method of claim 21, wherein the substrate comprises a tool joint.

27. The method of claim 21, wherein the alloy comprises:
from about 0.3 weight percent to about 5.0 weight percent carbon;
from about 4.0 weight percent to about 6.5 weight percent molybdenum;
from about 4.0 weight percent to about 6.5 weight percent niobium;
from about 0.0 weight percent to about 5.0 weight percent manganese;
from about 0.0 weight percent to about 2.0 weight percent boron; and
from about 0.0 weight percent to about 3.0 weight percent silicon,
the balance of the composition being iron, including impurities in trace amounts.

28. The method of claim 21, wherein the alloy comprises:
from about 1.0 weight percent to about 3.0 weight percent carbon;
from about 4.0 weight percent to about 6.0 weight percent molybdenum;
from about 4.0 weight percent to about 6.0 weight percent niobium;
from about 0.5 weight percent to about 3.5 weight percent manganese;
from about 0.5 weight percent to about 1.5 weight percent boron; and
from about 0.5 weight percent to about 2.0 weight percent silicon,
the balance of the composition being iron, including impurities in trace amounts.

29. The method of claim 21, wherein the alloy comprises:
from about 1.0 weight percent to about 2.0 weight percent carbon;
from about 4.5 weight percent to about 6.5 weight percent molybdenum;
from about 4.5 weight percent to about 6.5 weight percent niobium;
from about 1.0 weight percent to about 3.5 weight percent manganese;
from about 0.5 weight percent to about 1.5 weight percent boron; and
from about 0.5 weight percent to about 2.0 weight percent silicon,
the balance of the composition being iron, including impurities in trace amounts.

31. The method of claim 21, wherein the molybdenum and the niobium in the alloy composition are present in approximately equal amounts.

32. The method of claim 21, further comprising increasing a wear resistance of the substrate material while simultaneously providing a lower coefficient of friction of the alloy layer relative to a coefficient of friction of the substrate without the alloy.

33. The method of claim 21, wherein the method presents a substrate having a wear rate from about 0.175 g to about 0.275 g weight loss per 6,000 revolutions as determined using ASTM test method G-65.

34. A powdered admixture comprising:
from about 0.0 weight percent to about 5.0 weight percent carbon;
from about 2.5 weight percent to about 8.0 weight percent molybdenum;
from about 2.5 weight percent to about 8.0 weight percent niobium;
from about 0.0 weight percent to about 5.0 weight percent manganese;
from about 0.0 weight percent to about 3.0 weight percent boron; and
from about 0.0 weight percent to about 3.0 weight percent silicon,
the balance of the composition being iron, including impurities in trace amounts.

35. The powdered admixture of claim 34, comprising:
from about 0.3 weight percent to about 3.0 weight percent carbon;
from about 4.0 weight percent to about 6.5 weight percent molybdenum;
from about 4.0 weight percent to about 6.5 weight percent niobium;
from about 0.0 weight percent to about 5.0 weight percent manganese;
from about 0.0 weight percent to about 2.0 weight percent boron; and
from about 0.0 weight percent to about 3.0 weight percent silicon,
the balance of the composition being iron, including impurities in trace amounts

36. The powdered admixture of claim 34, comprising:
from about 1.0 weight percent to about 2.0 weight percent carbon;
from about 4.0 weight percent to about 6.5 weight percent molybdenum;
from about 4.0 weight percent to about 6.5 weight percent niobium;
from about 0.5 weight percent to about 3.5 weight percent manganese;
from about 0.5 weight percent to about 1.5 weight percent boron; and
from about 0.5 weight percent to about 2.0 weight percent silicon,
the balance of the composition being iron, including impurities in trace amounts

37. The powdered admixture of claim 34, comprising:
from about 1.0 weight percent to about 2.0 weight percent carbon;
from about 4.5 weight percent to about 6.5 weight percent molybdenum;
from about 4.5 weight percent to about 6.5 weight percent niobium;
from about 1.0 weight percent to about 3.5 weight percent manganese;
from about 0.5 weight percent to about 1.5 weight percent boron; and
from about 0.5 weight percent to about 2.0 weight percent silicon,
the balance of the composition being iron, including impurities in trace amounts

39. The powdered admixture of claim 34, wherein the molybdenum and the niobium are in approximately equal amounts.

40. A wear and corrosion resistant alloy on a substrate, the alloy comprising hard, ultrafine, transition metal particles dispersed in a matrix and comprising:
from about 0.0 weight percent to about 3.0 weight percent carbon;
from about 2.5 weight percent to about 8.0 weight percent molybdenum;
from about 2.5 weight percent to about 8.0 weight percent niobium;
from about 0.0 weight percent to about 2.0 weight percent boron; and
from about 0.0 weight percent to about 2.5 weight percent silicon,
the balance of the composition being iron, including impurities in trace amounts

41. An alloy according to claim 40, comprising:
from about 0.3 weight percent to about 3.0 weight percent carbon;
from about 3.0 weight percent to about 7.0 weight percent molybdenum;
from about 3.0 weight percent to about 7.0 weight percent niobium;
from about 0.5 weight percent to about 3.5 weight percent manganese;
from about 0.5 weight percent to about 2.0 weight percent boron; and
from about 0.5 weight percent to about 2.0 weight percent silicon,
the balance of the composition being iron, including impurities in trace amounts

42. An alloy according to claim 40, having a hardness from about 600 to about 900 DPH₃₀₀ (Vickers DPH (Diamond Pyramid Hardness) hardness, HV.3.

43. An alloy according to claim 40, having a hardness from about 55 Rc to about 67 Rc on the Rockwell-C hardness scale.

44. An alloy according to claim 40, having a wear rate from about 0.175 g to about 0.275 g weight loss per 6,000 revolutions as determined using ASTM test method G-65.

45. An alloy for welding to a surface to be abrasion resistant comprising by weight,
about 0.3 to about 3.0 percent carbon,
about 0.5 to about 2.0 percent boron,
about 2.5 to about 7.0 percent molybdenum,
about 2.5 to about 7.0 percent niobium,
about 0.5 to about 3.5 percent manganese,
about 0.6 to about 0.8 percent silicon,
and the balance iron, including impurities as trace elements,
the alloy having a hardness of from about 55 Rc (600 Hv) to about 67 Rc (900 Hv).

46. An industrial product having a surface subject to abrasion comprising, a layer of the alloy of claim 45 welded to the surface of the industrial product subject to such abrasion.

47. The industrial product of claim 46 comprising, a stabilizer having a cylindrical body and an internally threaded box and an externally threaded pin for connection in a string of drill pipe, stabilizer ribs having outer surfaces subject to the abrasion extending from an outer surface of the cylindrical body effective to stabilize the string of drill pipe in a well bore, and a layer of the alloy of claim 45 welded to the outer surfaces of the stabilizer ribs subject to the abrasion.

48. A tool joint for connecting together drill pipe, the tool joint having a cylindrical body, an internally threaded box which has an outer cylindrical surface of a diameter greater than the drill pipe, and an externally threaded pin including, at least one layer of the alloy of claim 45 welded to the outer cylindrical surface of one or both of the box or pin, thereby providing surface resistance to abrasion by silicious materials.

49. The tool joint of claim 48 where, the outer cylindrical surface of one or both the box or pin has a reduced diameter portion extending along a substantial portion of its length, and the layer of alloy is welded to the reduced diameter portion of one or both of the box and the pin.

50. A method of prolonging the life of an industrial product subject to abrasion of the order of silicious materials comprising, welding a layer of the alloy of claim 45 to one or more surfaces of the industrial product subject to the abrasion.

51. An alloy composition comprising:
from about 0.0 weight percent to about 5.0 weight percent carbon;
from about 2.5 weight percent to about 8.0 weight percent molybdenum;
from about 2.5 weight percent to about 8.0 weight percent niobium;
from about 0.0 weight percent to about 3.0 weight percent boron; and
the balance of the composition being iron, including impurities in trace amounts.

52. The alloy composition of claim 51, wherein the amount of carbon is between about 0.3 wt. % and about 3.0 wt. %.

53. The alloy composition of claim 51, wherein the amount of molybdenum and niobium is between about 4.0 wt. % and about 6.5 wt. %.

54. The alloy composition of claim 51, wherein the amount of boron is between about 0.5 wt. % and 1.5 wt. %.

55. The alloy composition of claim 51, further comprising manganese in an amount between about 0.5 wt. % and 3.5 wt. %.

56. The alloy composition of claim 51, further comprising silicon in an amount between about 0.5 wt. % and 3.5 wt. %.

57. A hardfacing alloy for welding to a surface to be abrasion resistant comprising by weight,
about 0.3 to about 3.0 percent carbon,
about 0.5 to about 2.0 percent boron,
about 2.5 to about 7.0 percent molybdenum,
about 2.5 to about 7.0 percent niobium,
about 0.5 to about 3.5 percent manganese,
about 0.6 to about 0.8 percent silicon,
and the balance iron, including impurities as trace elements,
the alloy having a hardness of from about 55 Rc (600 Hv) to about 67 Rc (900 Hv).

58. An industrial product having a surface subject to abrasion comprising, a layer of the hardbanding alloy of claim 57 welded to the surface of the industrial product subject to such abrasion.

59. The industrial product of claim 58 comprising, a stabilizer having a cylindrical body and an internally threaded box and an externally threaded pin for connection in a string of drill pipe, stabilizer ribs having outer surfaces subject to the abrasion extending from an outer surface of the cylindrical body effective to stabilize the string of drill pipe in a well bore, and a layer of the hardfacing alloy of claim 57 welded to the outer surfaces of the stabilizer ribs subject to the abrasion.

60. A tool joint for connecting together drill pipe, the tool joint having a cylindrical body, an internally threaded box which has an outer cylindrical surface of a diameter greater than the drill pipe, and an externally threaded pin including, at least one layer of the hardfacing alloy of claim 57 welded to the outer cylindrical surface of one or both of the box or pin, thereby providing surface resistance to abrasion by silicious materials.

61. The tool joint of claim 60 where, the outer cylindrical surface of one or both the box or pin has a reduced diameter portion extending along a substantial portion of its length, and the layer of hardfacing alloy is welded to the reduced diameter portion of one or both of the box and the pin.

62. A method of prolonging the life of an industrial product subject to abrasion of the order of silicious materials comprising, welding a layer of the hardfacing alloy of claim 57 to one or more surfaces of the industrial product subject to the abrasion.
